(19) United States
(12) Patent Application Publication
(10) Pub. No.: US 2008/0112788 A1
(43) Pub. Date: May 15, 2008

(54) Depalletizing Apparatus and Method

(75) Inventors: Don Cawley, Port Neches, TX (US); A. James Moore, Port Neches, TX (US)

Correspondence Address: FULBRIGHT & JAWORSKI L.L.P., 600 CONGRESS AVE., SUITE 2400, AUSTIN, TX, 78701, US

(73) Assignee: Sage Automation, Inc., Beaumont, TX (US)

(21) Appl. No.: 11/558,588

(22) Filed: Nov. 10, 2006

(51) Int. Cl. B65G 59/00; G06F 7/00

(52) U.S. Cl. 414/796.6; 700/213

(57) ABSTRACT

A depalletizing apparatus for separating stacked objects from a stack. In one embodiment, the depalletizing apparatus comprises a clamping assembly having a moveable arm with a proximal and distal end, the proximal end of the arm being operatively coupled to a first robotic mechanism and the distal end being operatively coupled to a clamp mechanism configured to close and secure the divider, wherein the divider is manipulated by movement of the arm, and a separating assembly having a separator arm configured to be inserted into the stack in the proximity of the divider that is engaged by the clamping assembly, wherein the separator is inserted into the stack at a position at or below the divider and the collection of stacked objects are positioned for depalletizing by formation of a gap between the collection of stacked objects and the divider.

### BACKGROUND OF THE INVENTION

I. Technical Field

The present invention generally relates to a method, system, and apparatus for securing a section of a vertical stack of generally flat product. More particularly, the invention is directed to a system, method, and apparatus for separating and transporting a collection of stacked objects from a stack with a depalletizing apparatus having a clamping assembly, and a stack separator assembly.

II. Background

A stack of flat product must be depalletized at some point in order for them to pass through to the next manufacturing process. The height of the stack that is picked is often limited by the loading capability of the next machine in the process, requiring that only portions of the column or stack be picked at a time. This depalletization is often done manually because it has not been possible to pick up portions of the columns without damaging the objects in some manner.

Stacks of cartons have been depalletized in the past by making special dividers from plastic or metal. The dividers would typically have a corrugated surface that would allow picking fingers to be inserted under a stack of cartons and lift them vertically. These dividers are an expense and must be reused and stored in order to be cost effective. When the stacks are depalletized manually, excess carton material is often used for the slip sheets, thus utilizing what is otherwise scrap material. The manual process, for example, utilizes a fork lift that inserts the lifting blade into the stack near the divider. The unfortunate result of direct insertion of a lifting blade into the stack is that a number of the objects will be damaged.

### SUMMARY OF THE INVENTION

In one embodiments of the invention there is a depalletizing apparatus for separating a collection of stacked objects from a stack, the apparatus comprising: (a) a clamping assembly having at least one moveable arm with a proximal and distal end, the proximal end of the arm being operatively coupled to a control mechanism and the distal end being operatively coupled to a clamp configured to secure and manipulate a divider, wherein the divider defines the bottom of a tier of the stack; and (b) a separating assembly having a substantially horizontal support member and a separator arm configured to move along the support member, wherein the separator arm is configured to be inserted into the stack at a position at or below the divider secured by the clamping assembly to position a collection of stacked objects for depalletizing. In certain aspects the separator arm is configured to move substantially horizontally. In a further aspect, the separator arm is configured to remain in the stack as the collection of stacked objects are depalletized. The stacked objects may be depalletized manual or automated removal of one or more of the collections of stacked objects. The separator arm can be a separator bar. In certain aspects the separator bar has a tapered leading edge. In a further aspect, the separator bar can be round, square, oblong, or triangular in cross section taken perpendicular to the long axis of the separator bar. In still further aspects of the invention, the support member can comprise at least one rail positioned along a side of the stack and parallel to the plane of the divider, and the separator arm may be configured to move substantially horizontally along the long axis of the rail. In certain aspects, the separating assembly comprises two rails positioned substantially parallel to each other. In an additional aspect of the invention the rails are configured to flank the stack when the depalletizing apparatus is separating the collection of stacked objects.

In certain embodiments the apparatus can further include a stack sensor configured to determine the position of the clamping assembly in relation to the stack and/or a gap sensor configured to detect a gap between the collection of stacked objects and the divider.

Other embodiments of the invention include methods for separating a collection of stacked objects from a stack, the method comprising: (a) providing a depallatizing apparatus having (i) a clamping assembly having a moveable arm with a proximal and distal end, the distal end being operatively coupled to a clamp mechanism configured to close on and secure a divider, wherein the divider is manipulated, and (ii) a separating assembly having a separator arm configured to be inserted into the stack in the proximity of the divider that is engaged by the clamping assembly, wherein the separator is inserted into the stack at a position at or below the divider and a collection of stacked objects are positioned for depalletizing by formation of a gap between the collection of stacked objects and the divider; (b) operably positioning the depalletizing apparatus in relation to a pallet of stacked objects; (c) securing an edge portion of a divider positioned within the stack with the clamping assembly configured to manipulate the divider when the clamp is in a closed position; (d) positioning the edge portion of the divider to allow insertion of a separator bar between the divider and a lower portion of the stack; (e) moving the separator bar to position the stacked objects for lifting; and (f) separating the collection of stacked objects. In certain aspects the method further comprises moving the clamping assembly downwardly to position the stack separator for insertion of a lifting implement. In other aspects the method steps (a)-(f) can be repeated one or more times. The method can further include, after removal of a first horizontal layer of collections of stacked objects, repositioning the separating assembly in a position to separate a second horizontal layer comprising collections of stacked objects.

In still further embodiments, there is an automated apparatus for facilitating the removal of objects from a stack that includes a first lower group of objects separated from a second upper group of objects by a divider, the automated apparatus comprising: (a) a clamping assembly; and (b) a separating assembly positioned to work with the clamping assembly, the separating assembly having a laterally-movable separator; (c) wherein the clamping assembly and the separating assembly are configured such that: (i) the clamping assembly is operable to engage and lift an end portion of the divider to expose a first gap between the divider and the first lower group of objects; (ii) the separating assembly is operable to laterally advance the laterally-movable separator through the first gap to a position under the divider and above the first lower group of objects; and (iii) the clamping assembly is operable to lower the end portion of the divider to expose a second gap between the divider and the second upper group of objects into which at least a portion of a lift blade, forklift, fingers, hands or other lifting implement can be inserted.

In yet other embodiments there is an automated apparatus for facilitating the removal of objects from a stack that includes a first lower group of objects separated from a second upper group of objects by a divider, the automated apparatus comprising: (a) a clamping assembly; (b) a separating assembly positioned to work with the clamping assembly, the separator assembly having a laterally-movable separator having a top; (c) where the clamping assembly and the separating assembly are configured such that: (i) the clamping assembly is operable to engage and lift an end portion of the divider; (ii) the separating assembly is operable to laterally advance the laterally-movable separator to a position under the divider and above the first lower group of objects; and (iii) the clamping assembly is operable to lower the end portion of the divider; (iv) where, after the clamping assembly lowers the end portion of the divider, the clamping assembly and the separating assembly work together to position a second group of objects so that at least a portion of a lift blade, forklift, fingers, hand or other lifting implement can be inserted.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### DESCRIPTION OF THE DRAWINGS

The following drawings illustrate by way of example and not limitation. Identical reference numerals do not necessarily indicate an identical structure. Rather, the same reference numeral may be used to indicate a similar feature or a feature with similar functionality. Every feature of each embodiment is not always labeled in every figure in which that embodiment appears, in order to keep the figures clear. The figures depict different aspects of embodiments of the present depalletizing apparatus.

FIGS. 1A-1B are an illustration of an assembly for depallatizing a collection of stacked objects. (FIG. 1A) right perspective view and (FIG. 1B) partial side view.

FIGS. 2A-2B are an illustration of the clamping assembly closing on a divider. (FIG. 2A) right perspective view and (FIG. 2B) partial side view.

FIGS. 3A-3B are an illustration of the clamping assembly operating in conjunction with the separating assembly to initiate tier separation. (FIG. 3A) right perspective view and (FIG. 3B) partial side view.

FIGS. 4A-4B are an illustration demonstrating the movement of the separating assembly into the stack. (FIG. 4A) right perspective view and (FIG. 4B) partial side view.

FIGS. 5A-5B are an illustration demonstrating the positioning of the separating assembly for movement of a collection of stacked objects by a lifting assembly, e.g., a lifting arm end effector. (FIG. 5A) right perspective view and (FIG. 5B) partial side view.

FIGS. 6A-6B are an illustration demonstrating an exemplary configuration operating in conjunction with a lifting arm end effector. (FIG. 6A) right perspective view and (FIG. 6B) partial side view.

FIGS. 7A-7B are an illustration demonstrating the movement of a collection of stacked objects from a palletized stack. (FIG. 7A) right perspective view and (FIG. 7B) partial side view.

FIGS. 8A-8B are an illustration demonstrating the depalletizing process on a second row of a tier of stacked objects. (FIG. 8A) right perspective view and (FIG. 8B) partial side view.

FIGS. 9A-9B are an illustration of an assembly for depallatizing a collection of stacked objects with the clamping mechanism is configured to allow a direct approach to the stack. (FIG. 9A) right perspective view and (FIG. 9B) partial side view.

### DETAILED DESCRIPTION OF THE INVENTION

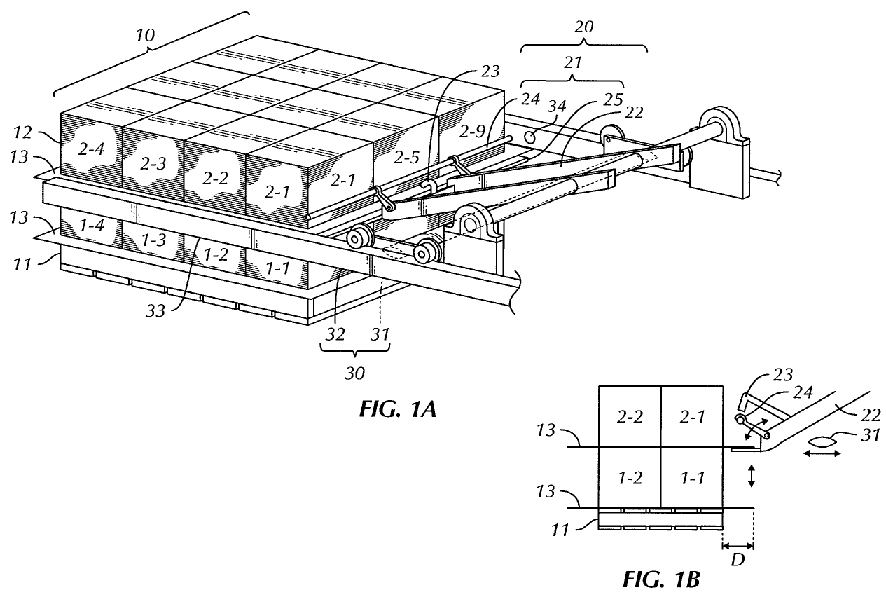

FIG. 1 illustrates a pallet of stacked products 10. Pallet 11 carries stacked flat product 12. These stacks may include carton blanks, disassembled cardboard boxes, stacked paper, disassembled stacked cartons and/or other generally flat materials. The stack may be divided and the divisions designated by their tier—column, e.g., stack 2-1 is in the second tier—column 1. Depending on the size of the product, there may be from one to twenty or more columns. A collection of stacked objects is a specific division of the stack that identifies a portion of the stack to be separated and moved from the stack (e.g., see 2-1, 2-5, and/or 2-9 of FIG. 1). Dividers or stack separators (e.g., slip sheets) 13 (often referred to as tie sheets) are placed in the columns at various levels to stabilize the columns. Typically, the generally flat materials all have the same shape or configuration. In the simplest form, this configuration is a square or other rectangle having four straight edges. In many applications, however, this configuration is a polygon having more than four edges. Typically, the present invention is utilized with generally flat, uniformly-configured items.

Also demonstrated in FIG. 1 is a depalletizing apparatus positioned for separating a collection of stacked product from a stack. The depalletizing apparatus includes clamping assembly 20 that comprises at least two components: clamp device 21 and movable arm 22, and optionally detector 23. The clamping assembly 20 includes bar 24 and plate 25, either one or both of which are attached to arm member 22.

Bar 24 and plate 25 of clamp device 20 typically are configured to open and close on divider 13. Bar 24 and plate 25 may include any surface that can be closed to secure divider 13 for manipulation. Bar 24 and plate 25 may be a plate. They can be made from various materials including metal, plastic and rubber. The surface of bar 24 and plate 25 can have a solid flat surface or contain openings through the bar and/or plate, or have grooves or other relief. A semi-rigid material allows clamp assembly 20 to flex when pushed against the side of the stack so as to reduce damage to the stacked product.

Bar 24 and plate 25 will typically clamp divider 13 along a substantial portion of its length, i.e., the plate can be continuous along its length. Alternatively, two or more plate pairs, opposed upper and lower plates, can be positioned so as to clamp the leading edge portion of divider 13 in one or more regions. When the clamp device 21 is closed over edge portion 14 of divider 13 clamping assembly 20 can manipulate edge portion 14 of divider 13. Edge portion 14 of divider 13 is that portion of the divider extending beyond a face of stack 10 and may include all or part of such an edge portion 14. In one embodiment, arm 22 is disposed in a generally vertical axis. In an alternate configuration, arm 22 may be generally horizontally disposed. To allow placement of clamp assembly 20 in an operable position relative to divider 13 and face of the stacked product 10, arm 22 can be moveable in all three dimensions, i.e., the x, y, and z axes.

Clamp device 21 may be operably coupled to detector 23 for positioning and movement of clamping assembly 20 during a depalletizing operation. Detector 23 is typically a stack sensor mounted or operably configured on clamp device 21. Detector 23 can be mounted on arm 22 adjacent to the top of clamp assembly 20. As arm 22 moves forward toward stack 10, detector 23 determines the position of clamping assembly 20 in relation to the face of stacked product 10 and/or divider 13 to be clamped. Detector 23 can be any type of sensor known in the art, such as a photoelectric, an optic, an ultrasonic, an inductive, a capacitive, a contact switch, or a pressure type of sensor. For example, a sensor may use or detect physical contact, electrical contact, various electromagnetic radiation (e.g., visible light, infrared beams, lasers, and the like), or sound that may be reflected from the target or projected from the device. A signal is detected or reflected from the side of stack 10 or divider 13 and the detection or signal return time is computed into a linear distance. Other types of sensors and/or proximity sensors are well known in the art.

Clamping assembly 20 and separating assembly 30 are configured to work together for insertion of separator 31 into stack 10. Separator 31 can be attached to separator assembly 30, which includes separator 31 and rail system 32 or other assembly, and configured to provide horizontal mobility to separator 31 so that separator 31 may be moved between an upper tier (tier 2) and lower tier (tier 1) of stacked objects and below a particular collection of stacked objects. Rail system 32 can include one or more rails to position separator 31. In certain aspects separator 31 will be moved between divider 13 and the lower collection of stacked objects (exemplified by tier 1 in the figures). Separator 31 is generally moveable in a horizontal direction to move into and out of the stack in relation to clamping assembly 20.

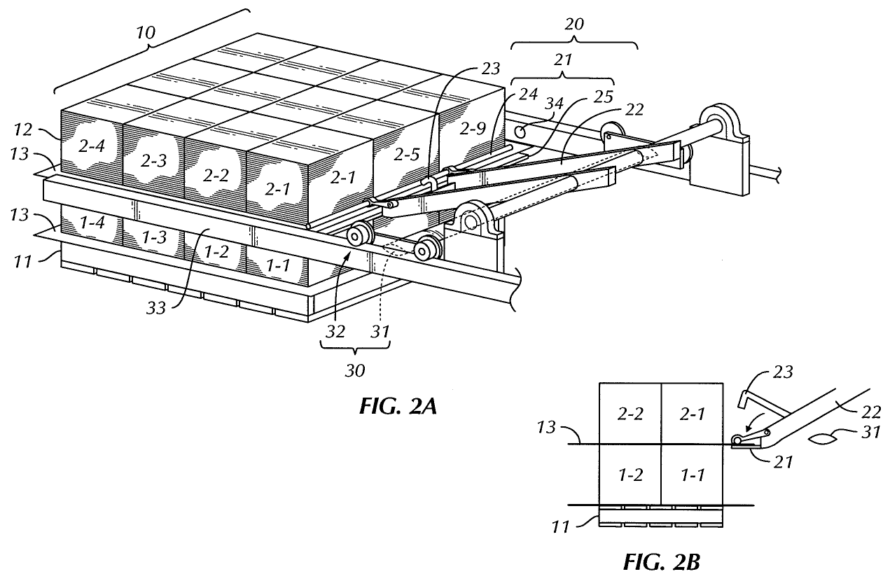

FIGS. 1B, 2B, 3B, 4B, 5B, 6B, 7B, and 8B illustrate various aspects of the operation of an embodiment of the depalletizing apparatus. FIG. 2B illustrates the closing of clamp device 21 onto divider 13, divider 13 being positioned between a first collection of stacks to be moved 2-1, 2-5, and/or 2-9, and a first tier of stacked objects (tier 1). Stack collections 2-1, 2-5, or 2-9 can be moved as a row or individually or in various combinations depending on the configuration of a lifting implement used to move the collections. A lifting implement may include a lifting blade, a product clamp that clamps a collection of stacked objects, or other end effectors used to move collections of stacked objects.

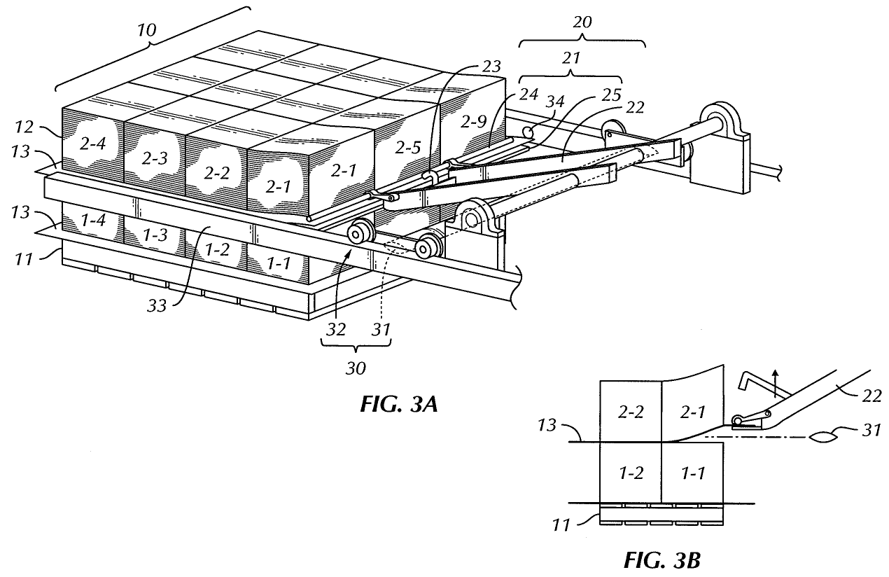

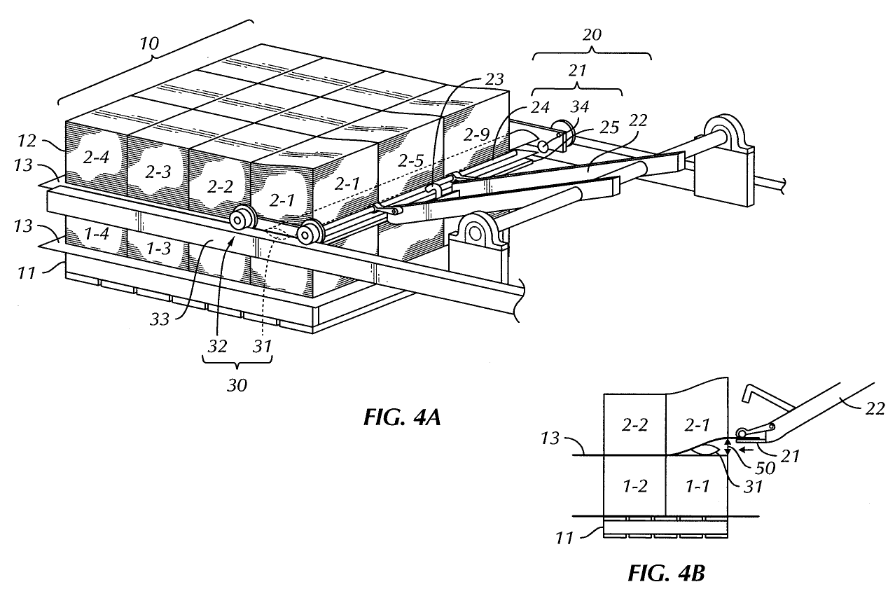

FIG. 3A and FIG. 3B illustrate the lifting of divider 13 by movement of clamping assembly 20 or alternatively movement of clamp device 21. Movement of clamping assembly 20 may be done by movement of the arm 22 or by upward movement of clamp device 21. Once divider 13 is lifted, separator 31 is moved into position for separating one or more collections of stacked objects creating a gap between the divider and the lower tier. Separating assembly 30 may also include a gap detector 34. The movement of separator 31 into the stack is illustrated in FIG. 4A and FIG. 4B.

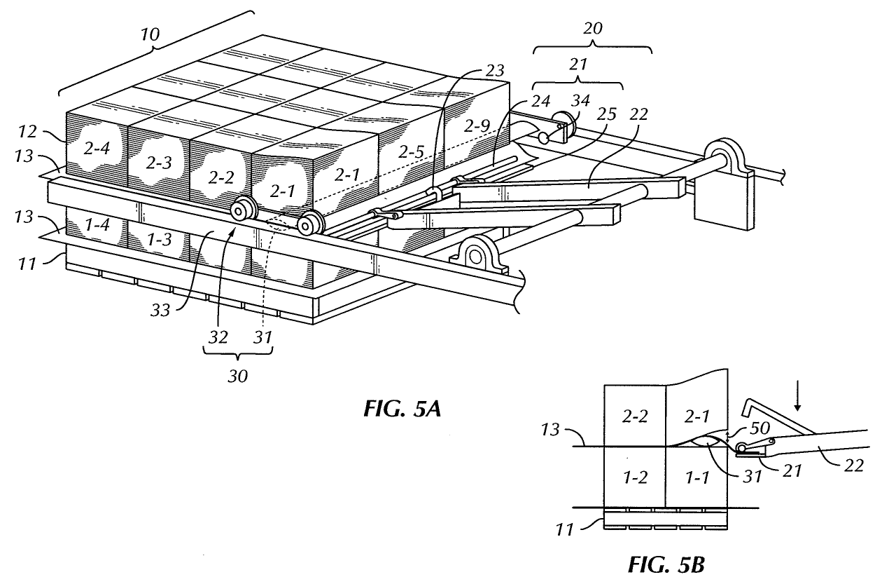

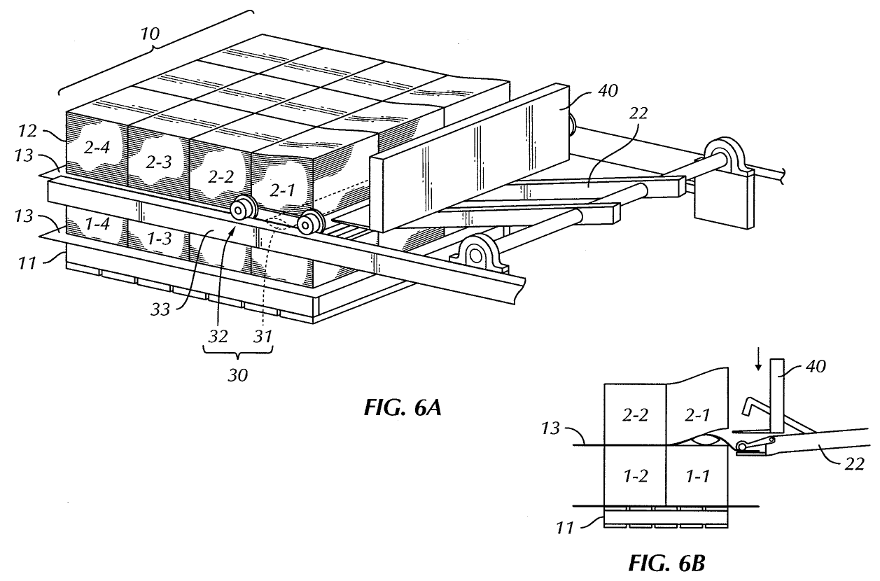

FIG. 5A and FIG. 5B illustrate the creation of a gap 50 by movement of clamp device 21, by movement of arm 22 or by movement of clamp device 21 downwardly. Gap 50 allows lifting implement 40 (FIG. 6B) to be positioned such that it can lift and/or move the collection of stacked objects from the stack.

FIG. 6A and FIG. 6B illustrate one alternative for the use of the depalletizing apparatus with lifting implement 40 (e.g., a lifting blade). Once separator assembly 30 has positioned a collection of stacked objects, lifting implement 40 is positioned for lifting and/or moving the separated collection of stacked objects. Positioning will typically be accomplished by combined movements along the x, y, and z axis. Lifting implement 40 may be configured to lift one or more collected stacks, i.e., those stacks of objects separated from the stack. In FIG. 6A 2-1, 2-5 and 2-9 collections are being lifted at the same time. The breadth of the lifting surface or the portion of the lifting surface inserted into the stack will determine how many collected stacks will be moved at once. The collected stacks may be moved individually or in various combinations.

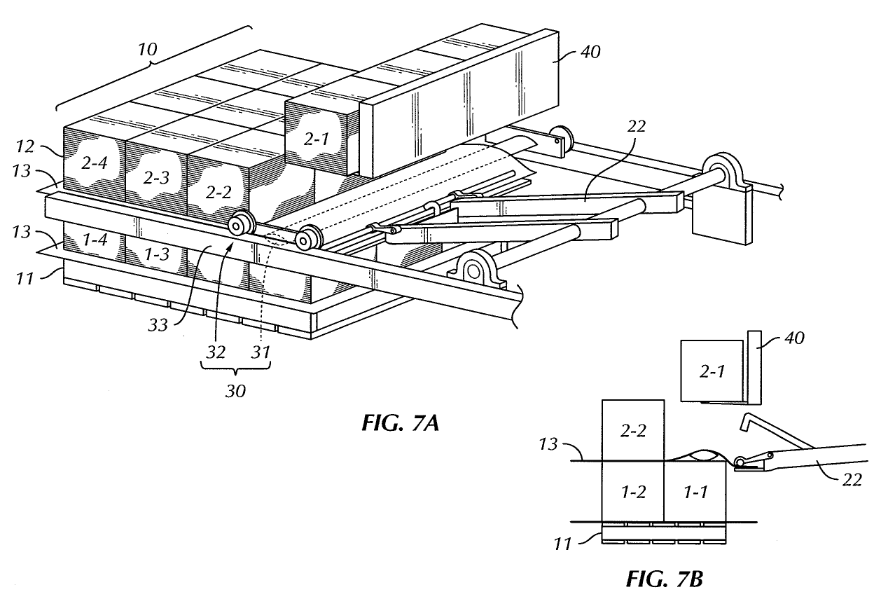

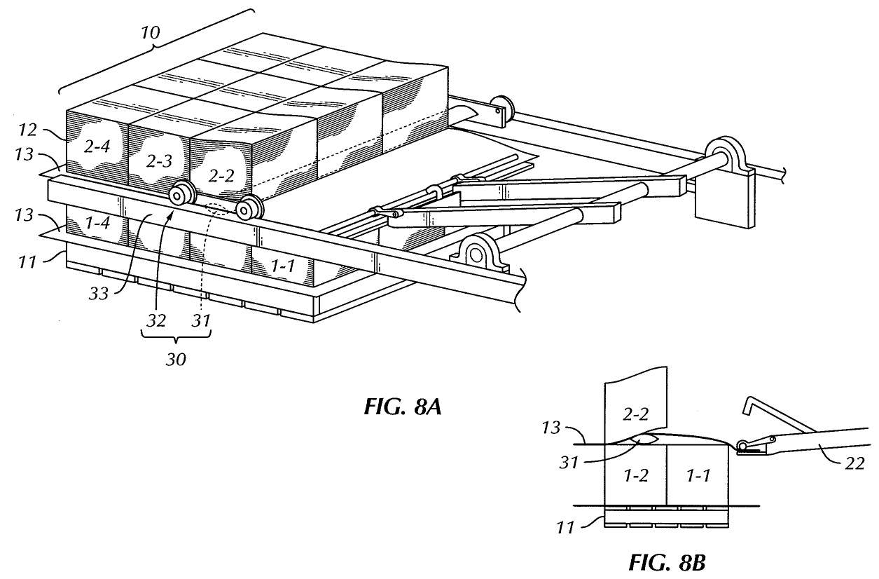

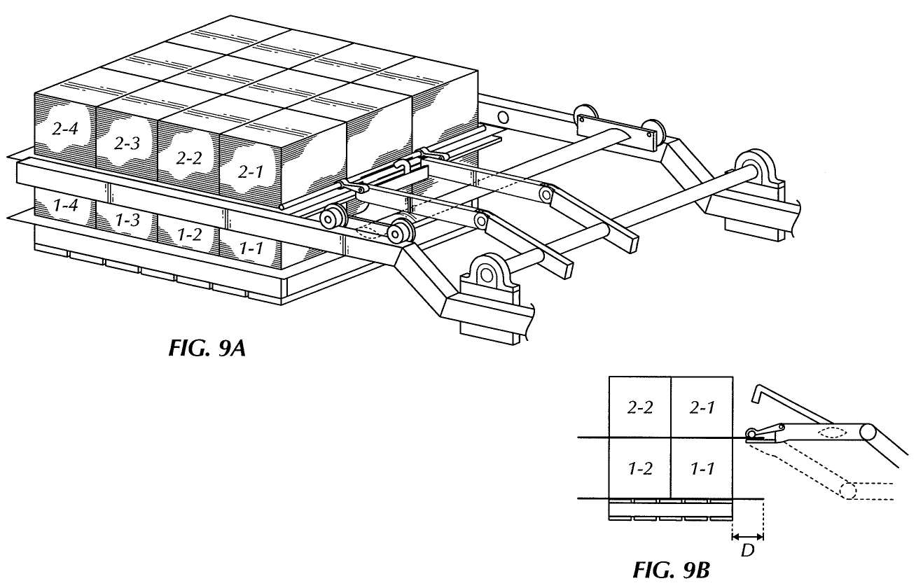

FIG. 7A and FIG. 7B further illustrate movement of collections of stacked objects from the stack and FIG. 8A and FIG. 8B illustrate the progression of the depalletizing apparatus to a second portion of a tier. In so doing, separator 31 is moved horizontally until the second collection of stacked objects (2-2 et al.) are positioned for insertion of the lifting implement as described above. This process can be repeated for a number of rows and/or columns present in any stack of objects. FIG. 9A and FIG. 9B illustrate an embodiment of the invention were the clamping mechanism is configured so that a lifting implent or the like can approach the stack on a perpendicular to the stack face. FIG. 9B, represents the clamping mechanism in an engaged and downward position.

The depalletizing system may also include a lifting assembly or be configured in such a manner as to be usable in conjunction with a lifting assembly. A lifting assembly can be independently moveable relative to the clamping and separating assemblies. The lifting assembly also may be interconnected to a frame. The frame may form a larger complex of systems that include the separating assembly and other moving and processing assemblies, such as a qualifying assembly.

By utilizing various combinations of universal joints, a robotic assembly may be programmed or otherwise operated to move through a full range of linear and angular motion. The arms of the device may be operably coupled to cylinders that are hydraulically actuated, or actuated by other means known in the art, such as an electro-mechanical device.

An embodiment of the depalletizing apparatus operates generally as described for FIGS. 1-9 above. After the separator is inserted into the stack and the side of a collection of stacked objects is positioned with a gap or space for insertion of a lifting implement, the product above the divider defines a collection of objects to be removed from the stack. The lifting implement is moveable into the stack for further supporting the collection of objects for lifting or moving. The lifting implement can be maneuvered to allow the lifted edge of the collection of stacked objects to settle down on the horizontal surface of the lifting implement and/or against a vertical face of the lifting implement. The collection of objects may also be tilted by movement of the lifting implement to secure the collection as it is moved.

Although the present invention and its advantages have been described in detail, it should be understood that various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one will readily appreciate from the disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. A depalletizing apparatus for separating a collection of stacked objects from a stack, the apparatus comprising:
(a) a clamping assembly having at least one moveable arm with a proximal and distal end, the proximal end of the arm being operatively coupled to a control mechanism and the distal end being operatively coupled to a clamp configured to secure and manipulate a divider, wherein the divider defines the bottom of a tier of the stack; and
(b) a separating assembly having a substantially horizontal support member and a separator arm configured to move along the support member,
wherein the separator arm is configured to be inserted into the stack at a position at or below the divider secured by the clamping assembly to position a collection of stacked objects for depalletizing.

2. The apparatus of claim 1, wherein the separator arm is configured to move substantially horizontally.

3. The apparatus of claim 1, wherein the separator arm is configured to remain in the stack as the collection of stacked objects are depalletized.

4. The apparatus of claim 2, wherein the separator arm is a separator bar.

5. The apparatus of claim 4, where the separator bar has a tapered leading edge.

6. The apparatus of claim 5, where the separator bar is round, square, oblong, or triangular in cross section taken perpendicular to the long axis of the separator bar.

7. The apparatus of claim 2, wherein the support member comprises at least one rail positioned along a side of the stack and parallel to the plane of the divider, and the separator arm is configured to move substantially horizontally along the long axis of the rail.

8. The apparatus of claim 7, where the separating assembly comprises two rails positioned substantially parallel to each other.

9. The apparatus of claim 8, where the rails are configured to flank the stack when the depalletizing apparatus is separating the collection of stacked objects.

10. The apparatus of claim 1, further comprising a stack sensor configured to determine the position of the clamping assembly in relation to the stack.

11. The apparatus of claim 1, further comprising a gap sensor configured to detect a gap between the collection of stacked objects and the divider.

12. A method for separating a collection of stacked objects from a stack, the method comprising:
(a) providing a depallatizing apparatus having
(i) a clamping assembly having a moveable arm with a proximal and distal end, the distal end being operatively coupled to a clamp mechanism configured to close on and secure a divider, wherein the divider is manipulated, and
(ii) a separating assembly having a separator arm configured to be inserted into the stack in the proximity of the divider that is engaged by the clamping assembly, wherein the separator is inserted into the stack at a position at or below the divider and a collection of stacked objects are positioned for depalletizing by formation of a gap between the collection of stacked objects and the divider;
(b) operably positioning the depalletizing apparatus in relation to a pallet of stacked objects;
(c) securing an edge portion of a divider positioned within the stack with the clamping assembly configured to manipulate the divider when the clamp is in a closed position;
(d) positioning the edge portion of the divider to allow insertion of a separator bar between the divider and a lower portion of the stack;
(e) moving the separator bar to position the stacked objects for lifting; and
(f) separating the collection of stacked objects.

13. The method of claim 12, further comprising moving the clamping assembly downwardly to position the stack separator for insertion of a lifting implement.

14. The method of claim 12, further comprising repeating (a)-(f) one or more times.

15. The method of claim 14, where, after removal of a first horizontal layer of collections of stacked objects, the separating assembly is positioned to separate a second horizontal layer comprising collections of stacked objects.

16. An automated apparatus for facilitating the removal of objects from a stack that includes a first lower group of objects separated from a second upper group of objects by a divider, the automated apparatus comprising:
(a) a clamping assembly; and
(b) a separating assembly positioned to work with the clamping assembly, the separating assembly having a laterally-movable separator;
(c) wherein the clamping assembly and the separating assembly are configured such that:
(i) the clamping assembly is operable to engage and lift an end portion of the divider to expose a first gap between the divider and the first lower group of objects;
(ii) the separating assembly is operable to laterally advance the laterally-movable separator through the first gap to a position under the divider and above the first lower group of objects; and
(iii) the clamping assembly is operable to lower the end portion of the divider to expose a second gap between the divider and the second upper group of objects into which at least a portion of a lift blade can be inserted.

17. An automated apparatus for facilitating the removal of objects from a stack that includes a first lower group of objects separated from a second upper group of objects by a divider, the automated apparatus comprising:
(a) a clamping assembly; and
(b) a separating assembly positioned to work with the clamping assembly, the separator assembly having a laterally-movable separator having a top;
(c) where the clamping assembly and the separating assembly are configured such that:
(i) the clamping assembly is operable to engage and lift an end portion of the divider to expose a first gap between the divider and the first lower group of objects;
(ii) the separating assembly is operable to laterally advance the laterally-movable separator through the first gap to a position under the divider and above the first lower group of objects; and
(iii) the clamping assembly is operable to lower the end portion of the divider;
(iv) where, after the clamping assembly lowers the end portion of the divider, the clamping assembly and the separating assembly work together to expose a second gap between the divider and the second upper group of objects into which at least a portion of a lift blade can be inserted.
